(19) United States
(12) Patent Application Publication
(10) Pub. No.: US 2025/0259010 A1
(43) Pub. Date: Aug. 14, 2025

(54) BENCHMARKING MODULAR NATURAL LANGUAGE PROCESSING PIPELINES

(71) Applicant: Cisco Technology, Inc., San Jose, CA (US)

(72) Inventors: Jayanth SRINIVASA, San Jose, CA (US); Ramana Rao V. R. KOMPELLA, Foster City, CA (US); Advit DEEPAK, San Jose, CA (US); Jason Matthew RAUCHWERK, San Jose, CA (US); Thomas LE MENESTREL, Stanford, CA (US)

(21) Appl. No.: 18/439,815

(22) Filed: Feb. 13, 2024

(51) Int. Cl. G06F 40/40; G06F 8/34; G06F 11/34

(52) U.S. Cl. CPC G06F 40/40; G06F 8/34; G06F 11/3428

(57) ABSTRACT

In one embodiment, a method herein comprises: obtaining, by a device, one or more modular natural language processing pipelines each having a respective plurality of selected pipeline stage components; processing, by the device, an input text by the one or more modular natural language processing pipelines to produce an output from each of the one or more modular natural language processing pipelines; generating, by the device, benchmarking metrics regarding each output processed from each of the one or more modular natural language processing pipelines; and providing, by the device, the benchmarking metrics on a visual dashboard interface for assessment of the benchmarking metrics corresponding to each of the one or more modular natural language processing pipelines.

### TECHNICAL FIELD

The present disclosure relates generally to computer networks, and, more particularly, to benchmarking modular Natural Language Processing (NLP) pipelines.

### BACKGROUND

In general, Natural Language Processing (NLP) pipelines are created to input, assess, and understand human language. For instance, chatbots and virtual assistants are built on NLP pipelines to allow a user to use simply communicate verbally with a computing device as they would another person.

NLP pipelines reuse many of the same components, but arranged in different orders. The purpose of each NLP model, though, varies from use-case to use-case. However, these models are not standardized in terms of their inputs, outputs, and hardware requirements. As a result, it is very difficult to interchange and combine NLP models, especially without introducing significant amounts of code. This lack of standardization causes NLP pipelines to be very inflexible.

In addition, even when an NLP pipeline has been created, another question remains: how well does that pipeline perform? Currently, it is possible to benchmark models themselves, but this does not account for the rest of the pipeline.

### BRIEF DESCRIPTION OF THE DRA WINGS

The embodiments herein may be better understood by referring to the following description in conjunction with the accompanying drawings in which like reference numerals indicate identically or functionally similar elements, of which:

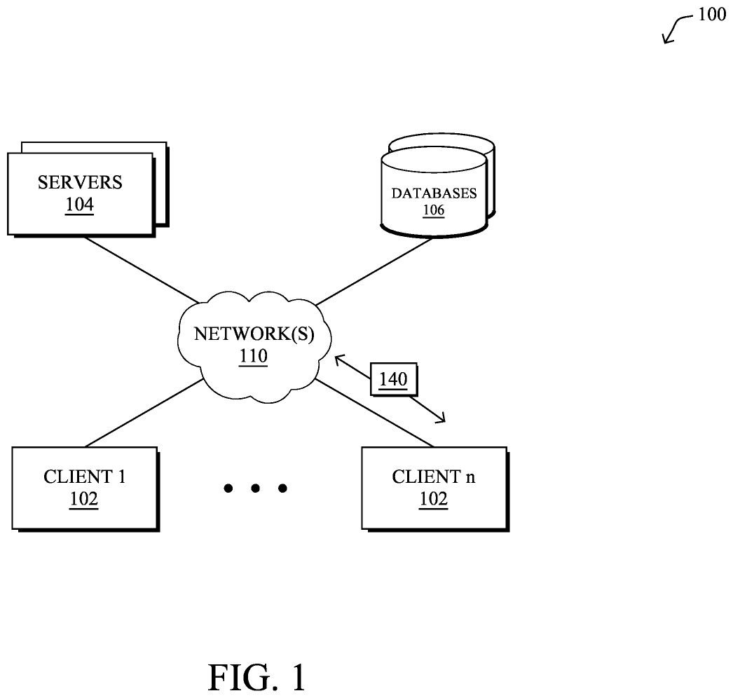

FIG. 1 illustrates an example computing system;

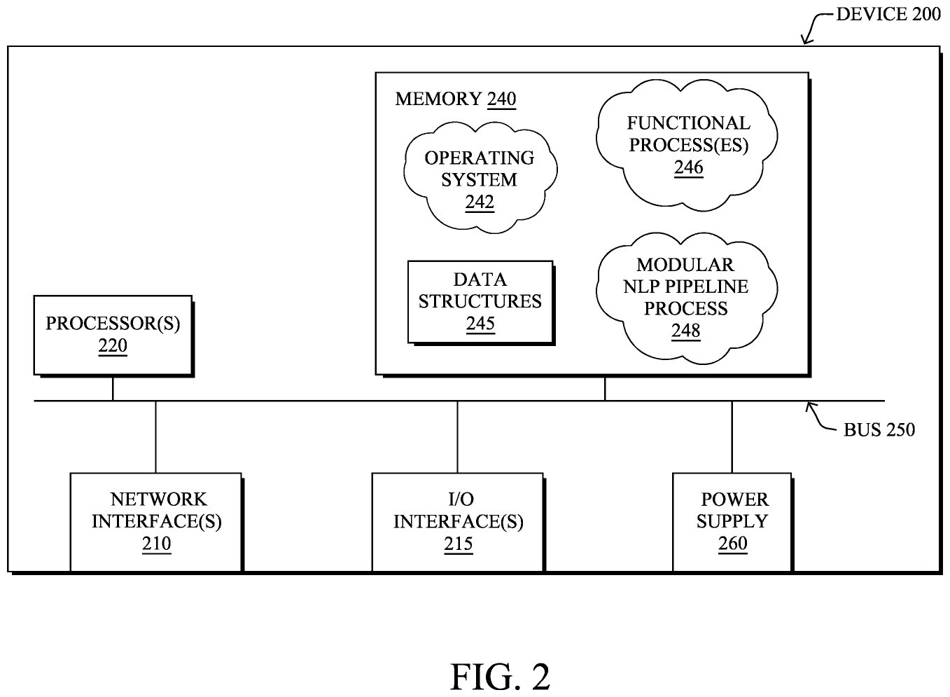

FIG. 2 illustrates an example network device/node;

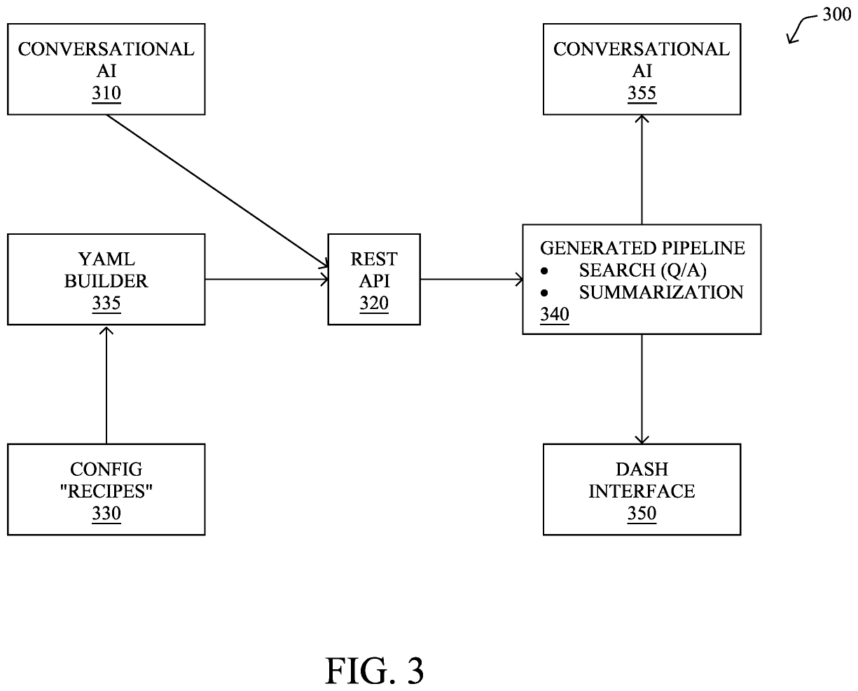

FIG. 3 illustrates an example architecture for modular Natural Language Processing (NLP) pipeline creation;

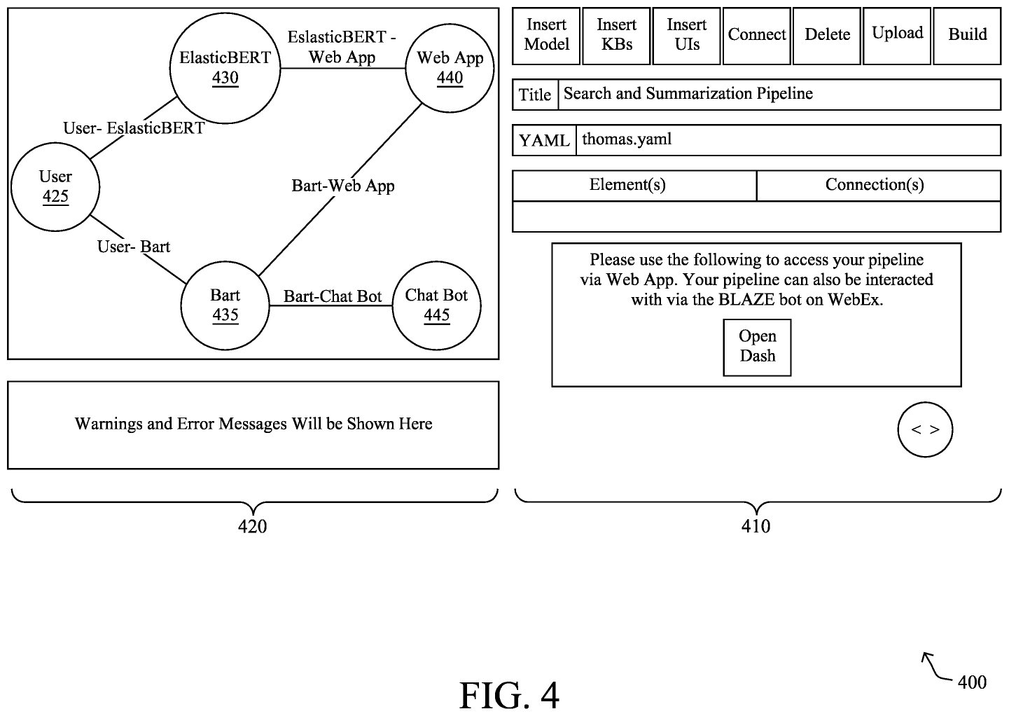

FIG. 4 illustrates an example drag-and-drop interface to generate NLP pipelines;

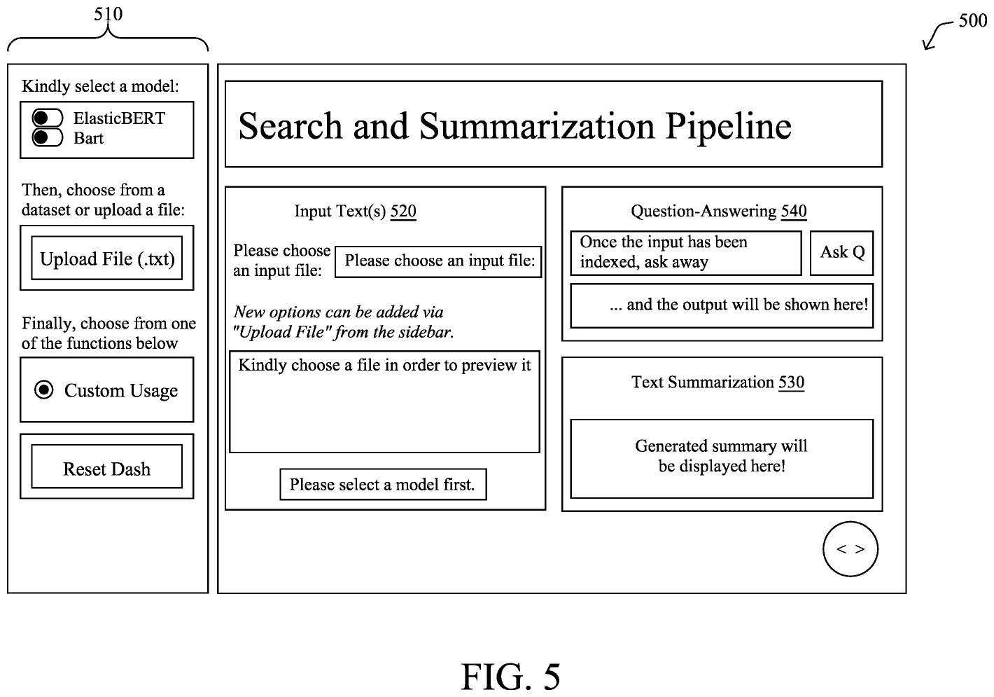

FIG. 5 illustrates an example dashboard to create models for NLP pipelines;

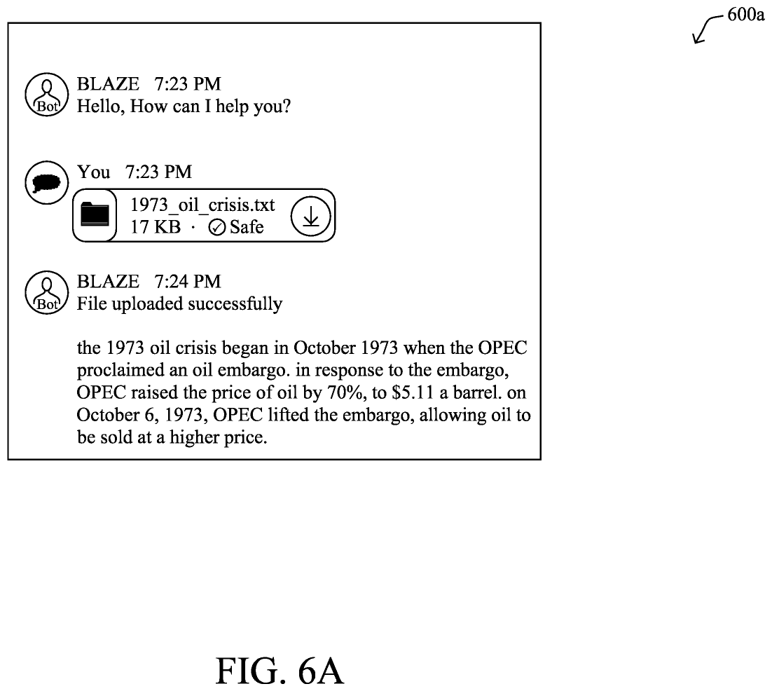

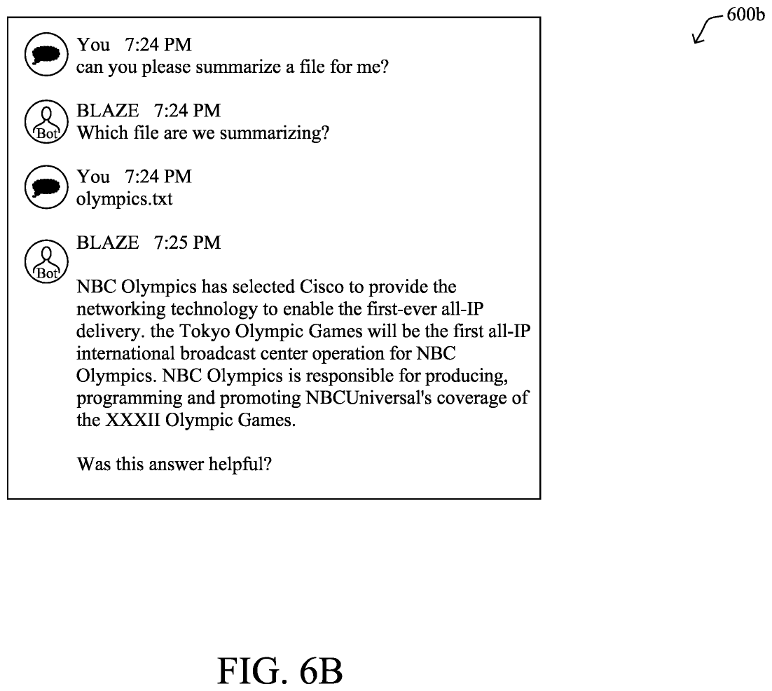

FIGS. 6A-6B illustrate examples of chatbot interfaces testing outputs of ingested input text into NLP pipelines;

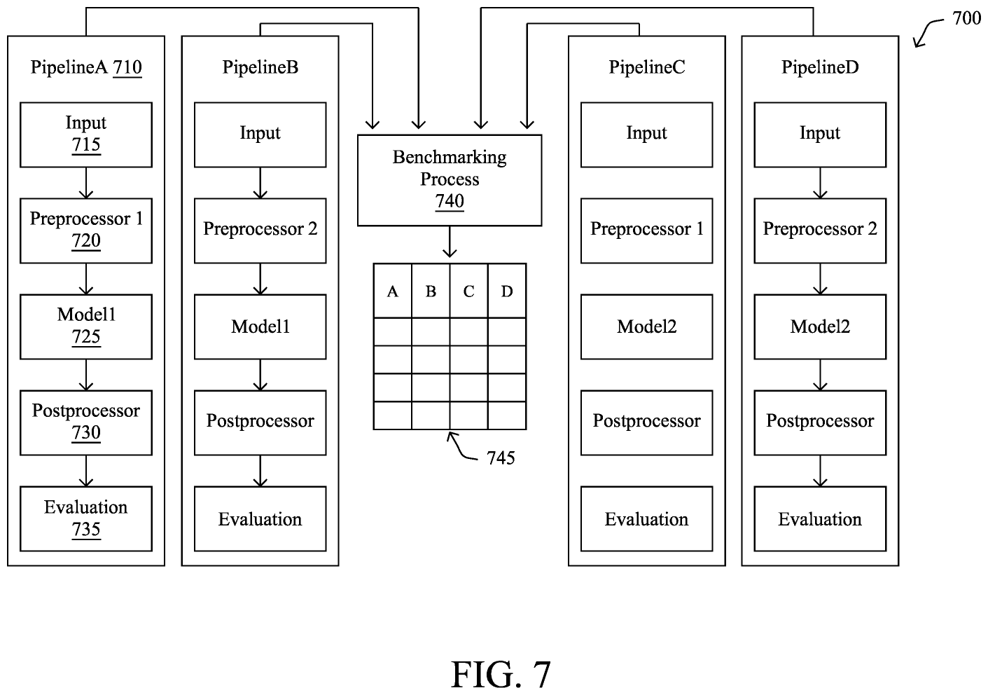

FIG. 7 illustrates an example of a comparison process for completed modular NLP pipelines;

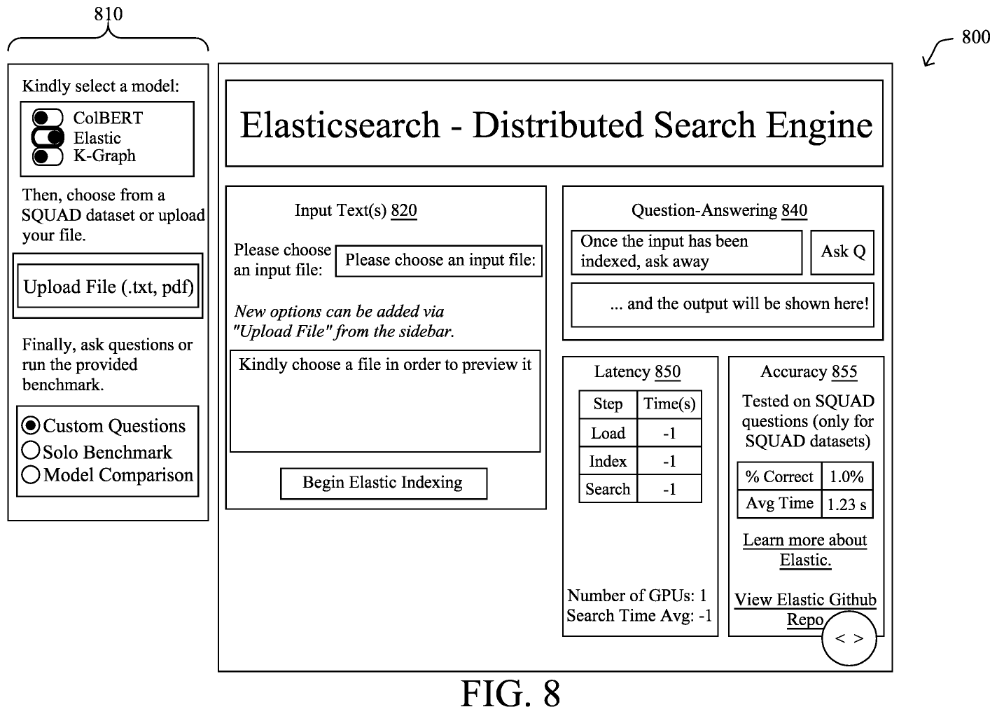

FIG. 8 illustrates an example of a dashboard for testing an NLP pipeline;

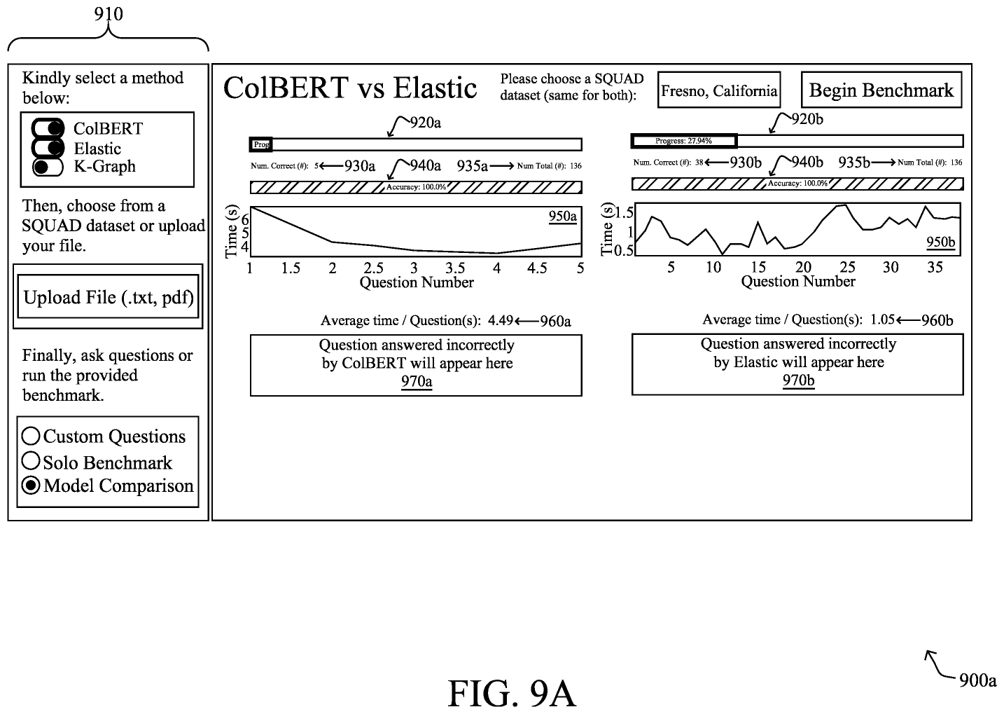

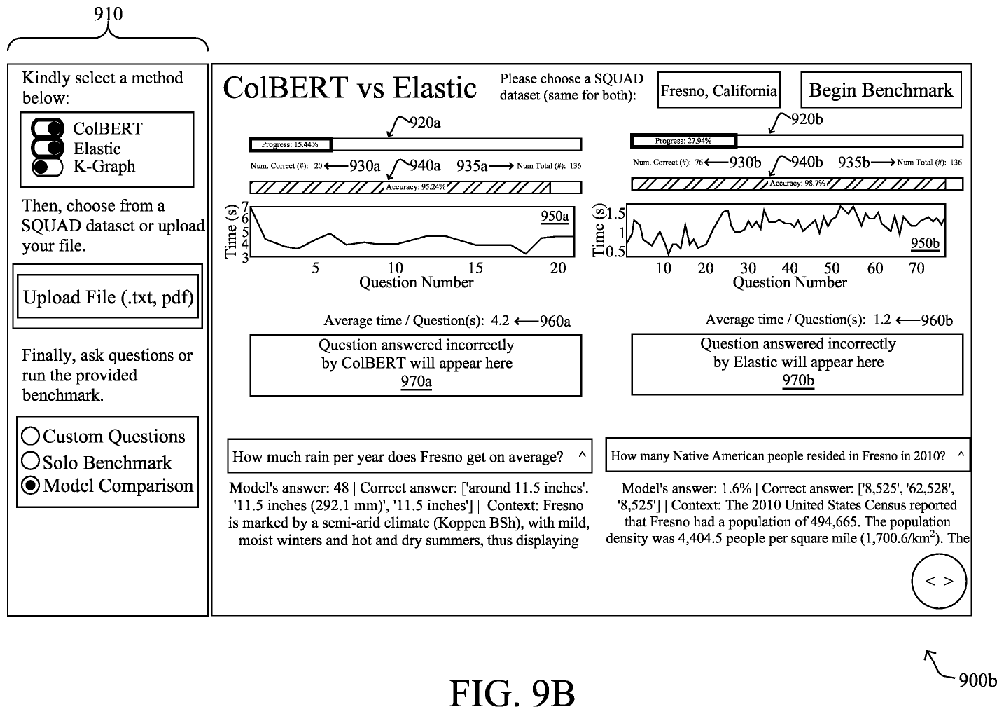

FIGS. 9A-9B illustrate examples of a dashboard for testing and comparing NLP pipeline versions;

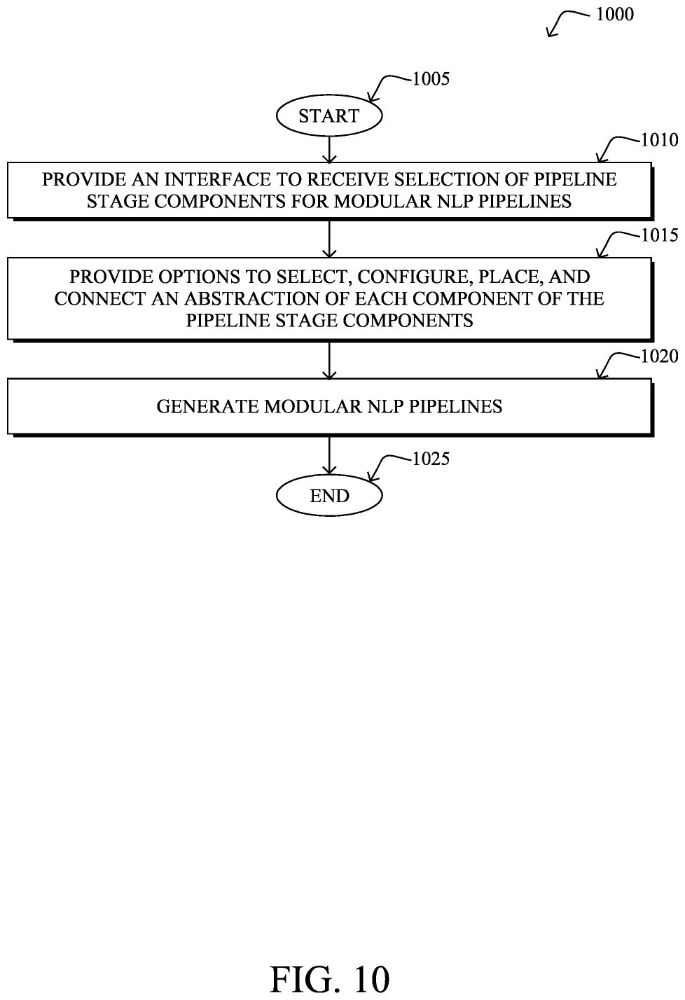

FIG. 10 illustrates an example procedure for establishing modular NLP pipelines; and

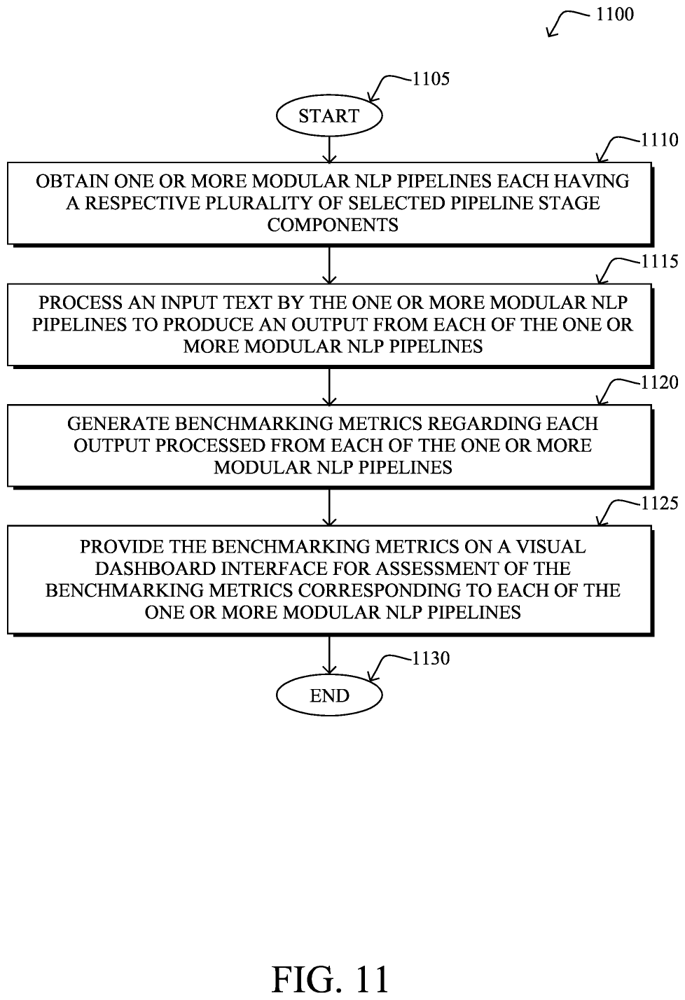

FIG. 11 illustrates an example procedure for benchmarking modular NLP pipelines.

### DESCRIPTION OF EXAMPLE EMBODIMENTS

### Overview

According to one or more embodiments of the disclosure, a method herein comprises: obtaining, by a device, one or more modular natural language processing pipelines each having a respective plurality of selected pipeline stage components; processing, by the device, an input text by the one or more modular natural language processing pipelines to produce an output from each of the one or more modular natural language processing pipelines; generating, by the device, benchmarking metrics regarding each output processed from each of the one or more modular natural language processing pipelines; and providing, by the device, the benchmarking metrics on a visual dashboard interface for assessment of the benchmarking metrics corresponding to each of the one or more modular natural language processing pipelines.

In one implementation, a method herein may comprise: providing an interface to receive selection of the respective plurality of selected pipeline stage components for the one or more modular natural language processing pipelines; providing options to select, configure, place, and connect an abstraction of each component of the respective plurality of selected pipeline stage components to form the one or more modular natural language processing pipelines; and generating a one or more modular natural language processing pipelines each having a respective plurality of selected pipeline stage components.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the in art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, a modular NLP pipeline process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

In various implementations, as detailed further below, modular NLP pipeline process (process 248) may include computer executable instructions that, when executed by processor(s) 220, cause device 200 to perform the techniques described herein. To do so, in some implementations, process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), model M can be used very easily to classify new data points. Often, M is a statistical model, and the cost function is inversely proportional to the likelihood of M, given the input data.

In various implementations, process 248 may employ one or more supervised, unsupervised, or semi-supervised machine learning models. Generally, supervised learning entails the use of a training set of data, as noted above, that is used to train the model to apply labels to the input data. For example, the training data may include sample network observations that do, or do not, violate a given network health status rule and are labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. Semi-supervised learning models take a middle ground approach that uses a greatly reduced set of labeled training data.

Example machine learning techniques that process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) ANNs (e.g., for non-linear models), replicating reservoir networks (e.g., for non-linear models, typically for time series), random forest classification, or the like.

In further implementations, process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, process 248 may use a generative model to generate synthetic network traffic based on existing user traffic to test how the network reacts. Example generative approaches can include, but are not limited to, generative adversarial networks (GANs), large language models (LLMs), other transformer models, and the like. In some instances, process 248 may be executed to intelligently route LLM workloads across executing nodes (e.g., communicatively connected GPUs clustered into domains).

The performance of a machine learning model can be evaluated in a number of ways based on the number of true positives, false positives, true negatives, and/or false negatives of the model. For example, the false positives of the model may refer to the number of times the model incorrectly predicted whether a network health status rule was violated. Conversely, the false negatives of the model may refer to the number of times the model predicted that a health status rule was not violated when, in fact, the rule was violated. True negatives and positives may refer to the number of times the model correctly predicted whether a rule was violated or not violated, respectively. Related to these measurements are the concepts of recall and precision. Generally, recall refers to the ratio of true positives to the sum of true positives and false negatives, which quantifies the sensitivity of the model. Similarly, precision refers to the ratio of true positives to the sum of true and false positives.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

### —Modular NLP Pipelines and Associated Benchmarking—

As noted above, Natural Language Processing (NLP) pipelines, which are built to understand human language, often reuse many of the same components, arranged in different orders according to their respective purpose from use-case to use-case. However, as also noted above, these models are not standardized in terms of their inputs, outputs, and hardware requirements, and it is thus very difficult to interchange and combine NLP models, especially without introducing significant amounts of code.

The techniques herein introduce a modular approach to constructing NLP pipelines whereby “building blocks” are arranged and connected, as desired. Such building blocks have standardized inputs and outputs, thereby allowing a developer to create a new NLP pipeline by simply connecting their desired building blocks.

As further noted above, however, even when an NLP pipeline has been created, another question remains: how well does that pipeline perform? Currently, it is possible to benchmark models, but this does not account for the rest of the pipeline. Moreover, due to the modular nature of the NLP pipelines created in accordance with the techniques herein, researchers and developers will want to scale different stages and find the solution that is the best fit for their specific use case.

The techniques herein, therefore, not only create NLP pipelines in a modular fashion, but also provide for quickly benchmarking and comparing different NLP models for use. In particular, modular NLP pipelines and associated benchmarking herein together provide a structured and adaptable approach to building, evaluating, and optimizing NLP systems. These techniques enhance ease-of-development, flexibility, and scalability while enabling data-driven decision-making for selecting the best-fit NLP solution for specific use cases.

Operationally, as mentioned above, the techniques herein introduce a modular NLP pipeline creation tool that allows developers to quickly develop NLP pipelines. As such, FIG. 3 illustrates an example of an architecture 300 for modular Natural Language Processing (NLP) pipeline creation. In particular, a conversational AI system 310 may be integrated with a web-based application or service such as a Representational State Transfer (REST) application programming interface (API), or REST API 320. The conversational AI system 310 may be a chatbot or conversational agent that can understand and generate natural language text or speech, and can be built using various technologies like NLP, machine learning, or rule-based approaches. To input conversational AI into a REST API, messages or queries may be sent to the API, such as HTTP requests (e.g., JSON or XML payloads), where these messages represent user queries or responses in a conversation with the chatbot.

Configuration recipes 330 are often used to define the desired configuration or settings for a particular task or application. In the context of a YAML builder 335 for input into a REST API 320, configuration recipes 330 can help structure and specify the parameters and options needed to make API requests. (Notably, YAML is a data serialization language that is often used for writing configuration files, as will be appreciated by those skilled in the art.) For example, by using configuration recipes in this manner, developers can easily change and manage the input parameters for the REST API requests by modifying the YAML file, making it more flexible and maintainable for various API interactions.

Output from the REST API 320 are the generated NLP pipelines 340, which can be seamlessly embedded within a wide range of software systems in several key use cases. For instance, as shown, the generated NLP pipelines 340 can be used for search (or “Q/A”) functions (e.g., where users can submit questions in natural language, and the system can process and search through vast datasets or knowledge bases to retrieve relevant answers) as well as article summarization (e.g., integrating NLP models to summarize lengthy articles or documents, whether located via search or via user-submitted texts or files, into more concise content that is digestible and accessible). Other specific use-cases may include such things as customer support chatbots, virtual assistants, e-commerce applications, and so on.

Specifically, these generated NLP pipelines 340 may be integrated into a specially configured interface 350 (e.g., a Dash interface) and/or another conversational AI system 355. For instance, Dash interfaces, in particular, are interactive web-based data dashboards that may be used to create a web-based front-end, which may be driven by the generated NLP pipelines as the backend. Users can interact with an associated chatbot or search functions through the specially configured interface 350 to access and configure the AI capabilities described herein. Conversely, the generated NLP pipelines 340 may also be integrated directly into a conversational AI system 355. For instance, the pipelines may be fed into a conversational AI system that manages the overall conversation context.

According to the techniques herein, using the architecture 300 above, two illustrative methodologies may be used to create flexible modular NLP pipelines: a visual “drag-and-drop” builder and a conversational AI chatbot. A drag-and-drop builder would allow users to assemble the building blocks for their desired pipelines from a visual interface. No coding would be required to incorporate any of the pipeline's components. The chatbot would allow users to specify which particular components (e.g., knowledge base, pre-processing steps, models, etc.) are desired for their given use case (e.g., search, summarization, toxicity score, etc.). This no-code solution would allow for ease and efficiency in composing and deploying using custom NLP pipelines.

As an example, FIG. 4 illustrates a drag-and-drop interface 400 to generate NLP pipelines according to one or more embodiments herein. For instance, menu 410 may provide options to select, establish, configure, and place (e.g., drag and drop) various individual components (nodes) to form a modular NLP pipeline 420. Menu 410 may include different options such as “insert model”, “insert KBs” (knowledge bases), “insert UI” (user interfaces), “connect”, “delete”, “upload”, “build”, and so on. Other fields, such as NLP pipeline title, YAML configs, and so on, may also be present within the menu 410. Each option may provide a list of corresponding abstractions of items, such as users 425, models (e.g., ElasticBERT 430 or BART 435), and UIs (e.g., Web App 440 and Chatbot 445), as shown. These nodes may then be connected in various manners as desired by the developer using the drag-and-drop interface 400 to create the modular NLP pipeline 420 according to their particular use case.

Other implementations beyond chatbots and drag-and-drop interfaces may be used in accordance with the embodiments herein to configure and generate NLP pipelines. That is, use of abstraction and standardized microservices by the techniques herein allows for quick addition of new interfaces such as smartphone apps and online meeting plug-ins, among others.

Another aspect of the present disclosure and the techniques described herein relates to a simplified mechanism to create a model for the pipeline. FIG. 5, for instance, illustrates an example dashboard (dashboard 500) to create models for NLP pipelines. Here, the developer is asked via an options menu 510 (e.g., a sidebar as shown) to simply select the type(s) of model(s) to use (e.g., BART for summarization, ElasticBERT for searching, etc.) and upload textual dataset(s) on which the model is to learn a knowledge base. Once the input text 520 has been ingested, a summary 530 of the text is output. In addition, the user is able to ask questions regarding the text (question-answering 540). For instance, say the input text is an article on the 1987 World Series. Once ingested, a user could ask the question: “How many games did the 1987 World Series go?”

Alternatively, a chatbot interface could also be used for testing outputs of ingested input text into NLP pipelines. For instance, FIGS. 6A-6B illustrate examples of such chatbot interfaces 600a-b, respectively. In FIG. 6A, for example, a chatbot (e.g., named “BLAZE”) prompts a user, who inputs a text file (e.g., regarding the oil crisis of 1973), to which the chatbot may reply with a summary of the successfully uploaded text file. The user may then be able to manually determine whether the summary is acceptable based on that summary or further interactions with the chatbot. Similarly, FIG. 6B illustrates another example where the user first asks the chatbot to summarize a file, prompting the chatbot to ask which file to summarize, at which time the user may indicate (or upload) the desired file, and the chatbot uses the modular NLP pipelines defined above, accordingly, to produce the appropriate summary. The user may then judge, and may offer feedback on, the quality of the answer generated.

In further aspects, the techniques herein also introduce a mechanism that allows developers, researchers, and other interested parties to quickly compare completed pipelines with benchmark data. Because each stage of an NLP pipeline may be hosted on its own microservice, the system herein can track the performance at intermediate points throughout the pipeline. In turn, the system can then provide immediate feedback with a scoring system that accounts for model accuracy, execution speed, latency, throughput, and other benchmarking metrics.

FIG. 7 illustrates an example of a comparison process 700 for completed modular NLP pipelines. In particular, each pipeline 710 of a set of compared pipelines (e.g., “PipelineA”, “PipelineB”, “PipelineC”, and “PipelineD”, as shown) may each comprise the following stages:
Input 715—The raw text or unstructured data that the pipeline will process, analyze, and transform into structured and meaningful information (e.g., text, documents, social media posts, websites and web pages, chat logs, emails and correspondence, speech transcriptions, text messages, medical records and reports, legal documents, books and publications, user-generated content, custom text data, and more)—generally a comparison process 700 uses the same input for suitable comparisons;
Preprocessor 720—Making the text data more amenable to NLP analysis and machine learning algorithms (e.g., cleaning and normalizing the text to reduce noise, improve the quality of extracted features, and enable more accurate and efficient processing by subsequent NLP components in the pipeline);
Model 725—The core processing and analysis of the input text data using selected pre-trained or custom-built NLP models to perform various language-related tasks, extract insights, or generate meaningful outputs—the choice of models and their configurations greatly influences the quality and effectiveness of the pipeline for specific NLP tasks;
Postprocessor 730—Enhancing the final output of an NLP system by addressing issues and improvements that arise after the initial text generation or processing steps, ensuring that the generated text meets the desired quality, style, and contextual requirements for various NLP applications; and
Evaluation 735—Assessing the system's performance, identifying strengths and weaknesses, and guiding further development efforts—providing insights into how well the NLP system meets its objectives and helps make informed decisions about model selection, hyperparameter tuning, and overall system improvement.

The outputs from each of these pipelines may then be shared with a benchmarking process 740, which can generate benchmarking data 745 in a format easily digestible to a developer to assess the strengths and weaknesses of each pipeline when compared to other pipelines being benchmarked.

This performance tracking, in conjunction with the user interface (UI) described above that makes it easy to swap out pipeline elements (e.g., drag-and-drop interface 400), allows researchers/developers to compare different pipelines. For instance, users can experiment with different combinations of preprocessors and models to find the best fit, where the benchmarking allows for a direct comparison, accordingly.

Another feature herein is the capability to allow users to perform effective A/B testing, by hosting multiple versions of the pipeline (with variations) and specifying the percentage of users that need to be served by different variation. All the versions of the pipeline can be run using the framework herein and performance can be easily measured end-to-end.

As shown in FIG. 7, in particular, PipelineA and PipelineB each share “Model1” as model 725, while PipelineC and PipelineD each share “Model2”. At the same time, however, PipelineA and PipelineC each use “Preprocessor 1” as preprocessor 720, while PipelineB and PipelineD each use “Preprocessor 2”. In this simple benchmarking comparison allowed by the modularity of the techniques herein, the developer can very easily compare the following NLP pipeline configurations against each other, in order to make the best fit selection for their particular use case:
Preprocessor 1, Model1;
Preprocessor 2, Model1;
Preprocessor 1, Model2; and
Preprocessor 2, Model2.

Further to the testing and comparison in accordance with the techniques herein, the dashboard can also be configured to allow for viewing the comparative results of the benchmarking described above. For instance, FIG. 8 illustrates an example of a dashboard 800 for testing an NLP pipeline, such as a semantic search implementation (e.g., Elasticsearch, a distributed search engine). In particular, menu 810 may be used to select between various methods (e.g., ColBERT or Elastic, as shown), and then selection of a particular SQUAD dataset or user uploaded set may then be prompted. Finally, menu 810 also asks whether custom questions are to be used, a solo benchmarking is to be performed, or a model comparison is to be made. Based on the selection of Elastic and custom questions as shown, the dashboard 800 shows boxes for input text(s) 820 and Question-Answering 840, and new benchmark measurement fields for latency 850 (e.g., steps and corresponding times, number of GPUs, search time average, etc.) and accuracy 855 (e.g., % correct, average time, etc.).

FIGS. 9A-9B illustrate examples of a dashboard for testing and comparing NLP pipeline versions. In FIG. 9A, for example, a first view 900a of the dashboard shows a first point in time during analysis, while FIG. 9B shows a second view 900b of the dashboard at a second point in time. As seen in the menu 910, both ColBERT and Elastic are selected as methods, and a model comparison is desired. Accordingly, progress bars 920a-b compare overall progress of the benchmark analysis testing for each method in a side-by-side view. Various comparative measurements may be displayed, such as, for example, the number correct 930a-b and a number total 935a-b, an accuracy 940a-b, a chart 950a-b plotting number of questions (x-axis) against time (y-axis), an average time 960a-b per question, and a field 970a-b for questions answered incorrectly by each method. As the comparative benchmarking analysis continues to progress (from first view 900a to second view 900b), the benchmarking values are updated accordingly, and incorrectly answered questions may be populated, and so on. This side-by-side comparison dashboard thus allows for easy comparative benchmarking between different configurations of NLP pipelines, accordingly.

In closing, FIG. 10 illustrates an example simplified procedure for establishing modular NLP pipelines in accordance with one or more embodiments described herein. For example, a non-generic, specifically configured device (e.g., device 200, an apparatus) may perform procedure 1000 by executing stored instructions (e.g., process 248). The procedure 1000 may start at step 1005, and continues to step 1010, where, as described in greater detail above, the techniques herein provide an interface to receive selection of a respective plurality of selected pipeline stage components for one or more modular natural language processing pipelines. For instance, as described above, the interface may be either a conversational artificial intelligence chatbot, a visual drag-and-drop interface of pipeline building blocks, or both. In step 1015, the techniques herein may provide options to select, configure, place, and connect an abstraction of each component of the respective plurality of selected pipeline stage components to form the one or more modular natural language processing pipelines. Lastly, in step 1020, the techniques herein may thus generate one or more modular natural language processing pipelines each having a respective plurality of selected pipeline stage components.

Procedure 1000 may end at step 1025.

In addition, FIG. 11 illustrates an example simplified procedure for benchmarking modular NLP pipelines in accordance with one or more embodiments described herein. For example, a non-generic, specifically configured device (e.g., device 200, an apparatus) may perform procedure 1100 by executing stored instructions (e.g., process 248). The procedure 1100 may start at step 1105, and continues to step 1110, where, as described in greater detail above, the techniques herein obtain one or more modular natural language processing pipelines each having a respective plurality of selected pipeline stage components. As noted above, the respective plurality of selected pipeline stage components may be based on one or more user-specified components selected from a group consisting of: knowledge bases; text datasets for training the knowledge bases; pre-processing steps; models; post-processing steps; user interface inputs; user interface outputs; and evaluation modules.

In step 1115, the techniques herein process an input text by the one or more modular natural language processing pipelines to produce an output from each of the one or more modular natural language processing pipelines, and in step 1120 generate benchmarking metrics regarding each output processed from each of the one or more modular natural language processing pipelines. As mentioned above, example benchmarking metrics may include accuracy, execution speed, latency, throughput, and others. As also detailed above, where each stage of the respective plurality of selected pipeline stage components of the one or more modular natural language processing pipelines is hosted on a respective microservice, the step 1120 may further comprise generating the benchmarking metrics based on performance at each of the respective plurality of selected pipeline stage components.

In step 1125, the techniques herein may then provide the benchmarking metrics on a visual dashboard interface for assessment of the benchmarking metrics corresponding to each of the one or more modular natural language processing pipelines. For instance, in one implementation described above, step 1125 may comprise providing a side-by-side visual comparison between benchmarking metrics of two or more differently configured modular natural language processing pipelines (e.g., where the side-by-side visual comparison is provided in real-time during simultaneous processing of the two or more differently configured modular natural language processing pipelines). Also, in another implementation as detailed above, the techniques herein may perform comparative testing (e.g., “A/B” testing) between two or more versions of a particular modular natural language processing pipeline, each of the two or more versions having at least one difference in the respective plurality of selected pipeline stage components from other versions of the two or more versions. (In one embodiment, the comparative testing may also involve receiving a specified percentage of users to be served by each of the two or more versions.)

Procedure 1100 may end at step 1130.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative apparatus herein may comprise: one or more network interfaces to communicate with a network; a processor coupled to the one or more network interfaces and configured to execute one or more processes; and a memory configured to store a process that is executable by the processor, the process, when executed, configured to: obtain one or more modular natural language processing pipelines each having a respective plurality of selected pipeline stage components; process an input text by the one or more modular natural language processing pipelines to produce an output from each of the one or more modular natural language processing pipelines; generate benchmarking metrics regarding each output processed from each of the one or more modular natural language processing pipelines; and provide the benchmarking metrics on a visual dashboard interface for assessment of the benchmarking metrics corresponding to each of the one or more modular natural language processing pipelines.

In still other implementations, a tangible, non-transitory, computer-readable medium storing program instructions that cause a device to execute a process comprising: obtaining one or more modular natural language processing pipelines each having a respective plurality of selected pipeline stage components; processing an input text by the one or more modular natural language processing pipelines to produce an output from each of the one or more modular natural language processing pipelines; generating benchmarking metrics regarding each output processed from each of the one or more modular natural language processing pipelines; and providing the benchmarking metrics on a visual dashboard interface for assessment of the benchmarking metrics corresponding to each of the one or more modular natural language processing pipelines.

The techniques described herein, therefore, provide for modular Natural Language Processing (NLP) pipelines and associated benchmarking. In particular, the techniques herein offer several advantages that address the challenges posed by non-standardized NLP models and the need for flexibility in constructing and evaluating NLP systems. First, modular NLP pipelines break down the NLP process into reusable and interchangeable building blocks or components with standardized inputs and outputs, making it easy to reuse well-tested components across different projects, reducing development time and effort. Developers can mix and match these building blocks to create custom NLP pipelines tailored to their specific use cases, allowing for the rapid prototyping of NLP solutions, accommodating the unique requirements of different applications without starting from scratch each time. Modular NLP pipelines also reduce the need to write extensive custom code for NLP-related tasks. Developers can leverage existing building blocks, reducing development overhead and accelerating the deployment of NLP solutions.

Moreover, due to the increased interchangeability offered herein, where developers can replace or upgrade specific components within the pipelines, it is thus easier to experiment with different models, libraries, or techniques. To assist in continuous improvement of NLP pipeline development, the techniques herein also provide for benchmarking of the NLP pipelines, allowing researchers and developers to evaluate the performance of the different pipelines and/or pipeline versions. With benchmarking data on the performance of different NLP pipelines, developers can compare and select the most suitable solution for their specific needs. This data-driven approach helps organizations make informed decisions about which NLP pipeline configuration works best for their applications.

Illustratively, the techniques described herein may be performed by hardware, software, and/or firmware, (e.g., an “apparatus”) such as in accordance with the modular NLP pipeline process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the intent and scope of the implementations herein. For example, while certain architectures, schemes, workloads, etc., are shown herein, the embodiments herein are not so limited.

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly. Also, while certain embodiments are described herein with respect to using certain models for particular purposes, the models are not limited as such and may be used for other functions, in other embodiments.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
obtaining, by a device, one or more modular natural language processing pipelines each having a respective plurality of selected pipeline stage components;
processing, by the device, an input text by the one or more modular natural language processing pipelines to produce an output from each of the one or more modular natural language processing pipelines;
generating, by the device, benchmarking metrics regarding each output processed from each of the one or more modular natural language processing pipelines; and
providing, by the device, the benchmarking metrics on a visual dashboard interface for assessment of the benchmarking metrics corresponding to each of the one or more modular natural language processing pipelines.

2. The method of claim 1, wherein each stage of the respective plurality of selected pipeline stage components of the one or more modular natural language processing pipelines is hosted on a respective microservice, the method further comprising: generating the benchmarking metrics based on performance at each of the respective plurality of selected pipeline stage components.

3. The method of claim 1, wherein the benchmarking metrics are selected from a group consisting of: accuracy; execution speed; latency; and throughput.

4. The method of claim 1, further comprising:
performing comparative testing between two or more versions of a particular modular natural language processing pipeline, each of the two or more versions having at least one difference in the respective plurality of selected pipeline stage components from other versions of the two or more versions.

5. The method of claim 4, further comprising:
receiving a specified percentage of users to be served by each of the two or more versions.

6. The method of claim 1, wherein providing the benchmarking metrics on the visual dashboard interface comprises:
providing a side-by-side visual comparison between benchmarking metrics of two or more differently configured modular natural language processing pipelines.

7. The method of claim 6, wherein the side-by-side visual comparison is provided in real-time during simultaneous processing of the two or more differently configured modular natural language processing pipelines.

8. The method of claim 1, further comprising:
providing an interface to receive selection of the respective plurality of selected pipeline stage components for the one or more modular natural language processing pipelines.

9. The method of claim 8, wherein the interface is either a conversational artificial intelligence chatbot, a visual drag-and-drop interface of pipeline building blocks, or both.

10. The method of claim 8, wherein providing the interface comprises:
providing options to select, configure, place, and connect an abstraction of each component of the respective plurality of selected pipeline stage components to form the one or more modular natural language processing pipelines.

11. The method of claim 1, wherein the respective plurality of selected pipeline stage components are based on one or more user-specified components selected from a group consisting of: knowledge bases; text datasets for training the knowledge bases; pre-processing steps; models; post-processing steps; user interface inputs; user interface outputs; and evaluation modules.

12. An apparatus, comprising:
one or more network interfaces to communicate with a network;
a processor coupled to the one or more network interfaces and configured to execute one or more processes; and
a memory configured to store a process that is executable by the processor, the process, when executed, configured to:
obtain one or more modular natural language processing pipelines each having a respective plurality of selected pipeline stage components;
process an input text by the one or more modular natural language processing pipelines to produce an output from each of the one or more modular natural language processing pipelines;
generate benchmarking metrics regarding each output processed from each of the one or more modular natural language processing pipelines; and
provide the benchmarking metrics on a visual dashboard interface for assessment of the benchmarking metrics corresponding to each of the one or more modular natural language processing pipelines.

13. The apparatus of claim 12, wherein each stage of the respective plurality of selected pipeline stage components of the one or more modular natural language processing pipelines is hosted on a respective microservice, the process, when executed, further configured to: generating the benchmarking metrics based on performance at each of the respective plurality of selected pipeline stage components.

14. The apparatus of claim 12, wherein the benchmarking metrics are selected from a group consisting of: accuracy; execution speed; latency; and throughput.

15. The apparatus of claim 12, wherein the process, when executed, is further configured to:
perform comparative testing between two or more versions of a particular modular natural language processing pipeline, each of the two or more versions having at least one difference in the respective plurality of selected pipeline stage components from other versions of the two or more versions.

16. The apparatus of claim 12, wherein the process, when executed to provide the benchmarking metrics on the visual dashboard interface, is configured to:
provide a side-by-side visual comparison between benchmarking metrics of two or more differently configured modular natural language processing pipelines.

17. The apparatus of claim 12, wherein the process, when executed, is further configured to:
provide an interface to receive selection of the respective plurality of selected pipeline stage components for the one or more modular natural language processing pipelines.

18. The apparatus of claim 17, wherein the interface is either a conversational artificial intelligence chatbot, a visual drag-and-drop interface of pipeline building blocks, or both.

19. The apparatus of claim 17, wherein the process, when executed to provide the interface, is configured to:
provide options to select, configure, place, and connect an abstraction of each component of the respective plurality of selected pipeline stage components to form the one or more modular natural language processing pipelines.

20. A tangible, non-transitory, computer-readable medium storing program instructions that cause a device to execute a process comprising:
obtaining one or more modular natural language processing pipelines each having a respective plurality of selected pipeline stage components;
processing an input text by the one or more modular natural language processing pipelines to produce an output from each of the one or more modular natural language processing pipelines;
generating benchmarking metrics regarding each output processed from each of the one or more modular natural language processing pipelines; and
providing the benchmarking metrics on a visual dashboard interface for assessment of the benchmarking metrics corresponding to each of the one or more modular natural language processing pipelines.
